(19) United States
(12) Patent Application Publication
(10) Pub. No.: US 2026/0008422 A1
(43) Pub. Date: Jan. 8, 2026

(54) Electrical Powertrain System for Mobile Crushers

(71) Applicant: Caterpillar Inc., Peoria, IL (US)

(72) Inventors: John Tanner, Dunlap, IL (US); Paul Muller, Peterborough (GB); Gareth Nelson, Rutland (GB)

(73) Assignee: Caterpillar Inc., Peoria, IL (US)

(21) Appl. No.: 18/763,352

(22) Filed: Jul. 3, 2024

(51) Int. Cl. B60R 16/033; B02C 21/02; H02J 7/00

(52) U.S. Cl. CPC B60R 16/033; B02C 21/02; H02J 7/0013; H02J 7/0063

(57) ABSTRACT

An electrical powertrain system for a mobile crusher is disclosed. The electrical powertrain system comprises a DC electrical supply network, a plurality of motors connected to the DC electrical supply network and configured to drive a plurality of machine operations, a plurality of batteries connected to the DC electrical supply network, providing electrical energy, a power distribution unit (PDU) managing DC power to different components of the mobile crusher, and a control unit configured to manage a charging and discharging cycles of the plurality of batteries for operation of the plurality of machine operations.

### TECHNICAL FIELD

The present disclosure generally relates to mobile crushers, and more particularly relates to electrical powertrain systems for mobile crushers.

### BACKGROUND

Mobile crushers such as rock crushers are mobile pieces of equipment in the construction and mining industries, used to break down large rocks into smaller, more manageable sizes for further processing. They generally consist of multiple components, including a crushing assembly, frame, and powertrain system. Reliable power is crucial for the operation of these machines, ensuring they can withstand heavy loads and operate continuously over long periods.

The powertrain system, which includes an electric motor, batteries, and other power sources, plays a vital role in providing the necessary mechanical force to the rock crushing assembly. As the construction and mining sectors increasingly shift towards electric and zero-emission options, integrating these power sources into the existing architecture poses significant challenges due to varying operational requirements. Traditionally, rock crushers have relied on AC electrical systems to power their operations. AC systems are well-established and can effectively distribute power over long distances with minimal loss. However, AC power systems can be less efficient in terms of energy conversion and storage, particularly when integrating renewable energy sources or batteries.

For instance, U.S. Pat. No. 4,438,383A discloses a motor control circuit for rock crushers, aimed at preventing relay dropouts during momentary power interruptions. However, it relies on an AC power system with a DC voltage storage capacitor. This system is not optimized for the integration of modern power sources, such as batteries, and does not adequately address the challenges of using multiple power sources to achieve flexibility and operational efficiency in rock crushing applications.

Hence, there exists a need for a rock crusher powertrain system that can seamlessly integrate multiple power sources, including grid power, generators, and batteries, into a simplified electrical bus architecture, providing power flexibility, zero-emission mobility, and robust component leveraging.

### SUMMARY

In accordance with one aspect of the disclosure, an electrical powertrain system for a mobile crusher is disclosed. The electrical power-train system comprises: a DC electrical supply network; a plurality of motors connected to the DC electrical supply network and config-ured to drive a plurality of machine operations; a plurality of batteries connected to the DC electrical supply network, providing electrical energy; a power distribution unit (PDU) managing DC power to different components of the mobile crusher; and a control unit configured to manage a charging and discharging cycles of the plurality of batter-ies for operation of the plurality of machine operations.

In accordance with another aspect of the disclosure, a mobile crusher is disclosed. The mobile crusher comprises: a frame; ground engaging elements supporting the frame; a rock crushing assembly mounted on the frame, configured to process rocks into smaller pieces; an electrical powertrain system including: a DC electrical supply network mounted to the frame; a plurality of motors connected to the DC electrical supply network and configured to drive a plurality of machine operations; a plurality of batteries connected to the DC electrical supply network, providing electrical energy; a power distribution unit (PDU) managing DC electrical power to different components of the mobile crusher; and a control unit configured to manage a charging and discharging cycles of the plurality of batteries for operation of the plurality of machine operations.

In accordance with another aspect of the disclosure, a method of powering a mobile crusher having a DC electrical supply network from a plurality of power sources is disclosed. The method comprises: initializing, via a control unit, to evaluate the status of the plurality of power sources; selecting a power source chosen from the plurality of power sources based on availability, cost, and environmental conditions; managing the power distribution from the selected primary power source to the DC electrical supply network and a plurality of mobile crusher operational systems, via the control unit; continuously monitoring, via the control unit, the operational conditions and state of the plurality of power sources; cycling power distribution between the plurality of power sources to the plurality of mobile crusher operational systems.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a mobile crusher, according to an embodiment of the present disclosure.

FIG. 2 is a schematic diagram illustrating a powertrain control system, according to an embodiment of the present disclosure.

FIG. 3 is a block diagram illustrating a DC powertrain system, according to another embodiment of the present disclosure.

FIG. 4 is a block diagram illustrating a second DC powertrain system, according to another embodiment of the present disclosure.

FIG. 5 is a flow chart of the method for cycling between power sources, including grid, generator, and battery, to power the rock crusher machine, according to another embodiment of the present disclosure.

The figures depict one embodiment of the presented disclosure for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a mobile crusher 100 is shown, illustrated as an exemplary rock crusher for crushing large rocks into smaller pieces. While the following detailed description describes an exemplary aspect in connection with the rock crusher, it should be appreciated that the description applies equally to the use of the present disclosure in other rock processing equipment, including, but not limited to, mobile crushers, stationary crushing units, mobile crusher with or without screening equipment, and modular crushing systems.

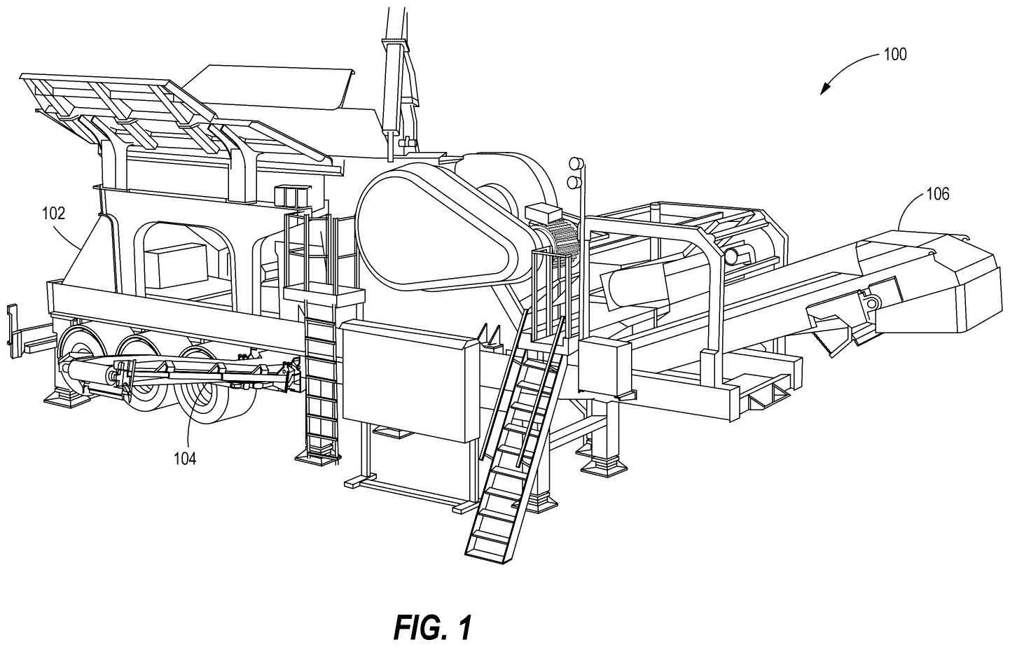

Referring now to FIG. 1, the mobile crusher 100 comprises a frame 102, according to an embodiment of the disclosure. The frame 102 is supported on ground engaging elements 104, illustrated as continuous tracks. It should be contemplated that the ground engaging elements 104 may be any other type of ground engaging elements such as, for example, wheels, track drive units, etc., that provide mobility to the mobile crusher 100. The mobile crusher 100 further includes a rock crushing assembly 106 mounted on the frame 102, configured to mechanically process rocks into smaller granules or dust.

The rock crushing assembly 106 may be a jaw crusher, cone crusher, or impact crusher, each suitable for different crushing applications and material types. The jaw crusher variant may use compressive force for breaking rocks between two hard surfaces, while the cone crusher might employ a rotating spindle and a concave surface for finer crushing. Alternatively, the impact crusher could utilize high-speed impact force from hammers or blow bars to shatter rocks upon high-velocity collision.

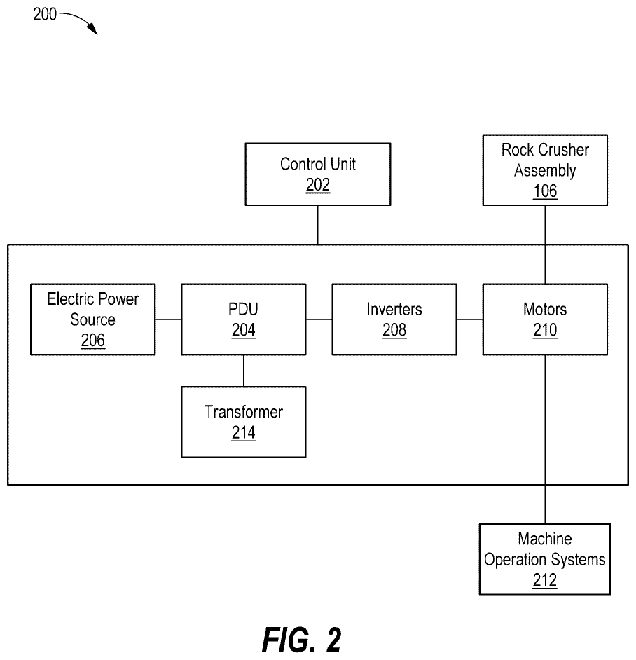

Now referring to FIG. 2, FIG. 2 illustrates a power control system 200 of the mobile crusher 100 is illustrated, according to one embodiment of the disclosure. A control unit 202 is provided to communicate and control a DC electrical supply network comprising a plurality of power sources 204, a power distribution unit 206 (“PDU 206”), a plurality of inverters 208, a plurality of motors 210, a plurality of machine operational systems 212, and a transformer 214, also in communication with the mobile crusher 100, the ground engaging elements 104, and the rock crushing assembly 106.

The control unit 202 is a central component of the power control system 200, orchestrating the seamless operation of the mobile crusher 100 by managing and coordinating various power sources and system components. This control unit 202 is equipped with advanced algorithms and real-time data processing capabilities that allow it to dynamically adjust power distribution based on operational demands and available power sources. The control unit 202 interfaces with multiple sensors distributed across the system to monitor the status and performance of the battery, generator, and grid connections. It also oversees the operation of the PDU 206, ensuring that the appropriate amount of power is delivered from the plurality of power sources 204 to the plurality of inverters 208, the plurality of motors 210, the plurality of machine operational systems 212, the transformer 214, the ground engaging elements 104, and the rock crushing assembly 106. The plurality of motors 210 may provide power to the ground engaging elements 104 to provide mobility to the mobile crusher 100.

By continuously analyzing the operational conditions and adjusting power flows, the control unit 202 ensures that the rock crushing assembly 106 operates at peak performance, thereby enhancing the overall productivity and reliability of the mobile crusher 100. This sophisticated control mechanism not only maximizes energy efficiency but also provides the flexibility to switch between or combine different power sources.

The processor is supported by memory modules that store operational data, control algorithms, and system parameters, ensuring quick access and efficient processing. The control unit 202 also includes input/output (I/O) interfaces that facilitate communication with the power sources, PDU 206, inverters 208, motors 210, and other machine operational systems 212. These interfaces enable the control unit 202 to send control signals and receive feedback from each component, ensuring coordinated and responsive system operation. Additionally, the control unit 202 is equipped with communication modules that allow for remote monitoring and control, enabling operators to adjust settings and monitor system performance from a distance. The control unit 202 can effectively manage the diverse and dynamic power requirements of the mobile crusher 100, providing reliable and efficient operation in various environmental conditions.

DC electrical systems offer several advantages for modern mobile crushers. DC systems provide more efficient energy conversion and are better suited for integrating renewable energy sources and batteries, which naturally produce DC power. The ability to directly use DC power from batteries and solar panels without the need for conversion to AC reduces energy loss and enhances overall system efficiency. However, managing DC power systems requires advanced control mechanisms, such as the control unit 202, to ensure stable and reliable power delivery under varying operational conditions. Utilizing DC systems over AC systems in mobile crushers, such as the mobile crusher 100, integrates multiple power sources, optimizes energy use, and maintains the operational efficiency and reliability of the equipment in the mobile crusher 100. By leveraging DC electrical systems and incorporating control units and power management strategies, the mobile crusher 100 can achieve superior performance and adaptability in diverse industrial applications over traditional AC electrical systems in mobile crushers.

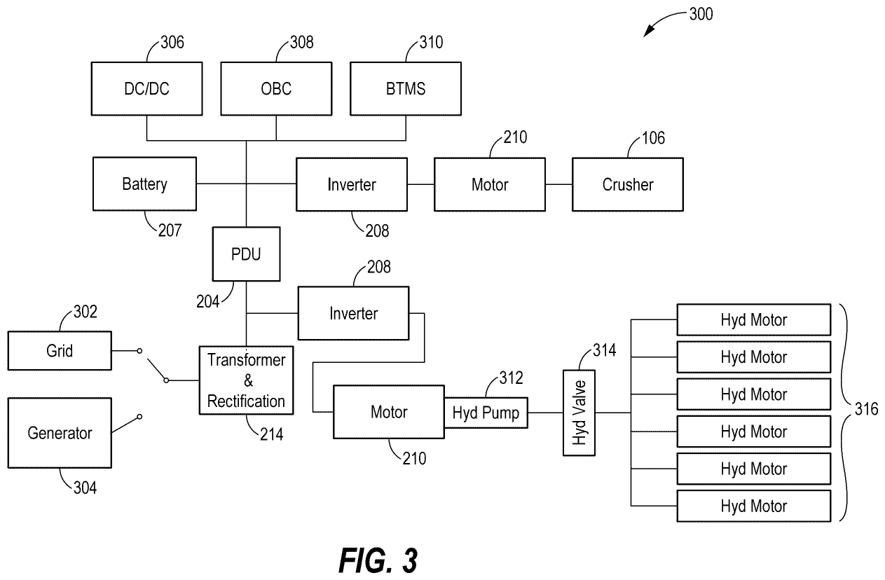

Referring now to FIG. 3, FIG. 3 illustrates a DC powertrain system 300 of the mobile crusher 100, according to an embodiment of the present disclosure. The DC powertrain system 300 is designed to manage and coordinate the various power sources and components to ensure efficient and reliable operation of the mobile crusher 100

The DC powertrain system 300 includes a connection to a grid 302 and a generator 304, both of which can provide electrical power to the system. The grid 302 allows the mobile crusher 100 to draw power from an external power grid, while the generator 304 provides an alternative or supplemental power source, especially useful in remote or off-grid locations. The generator 304 may be a diesel generator or a renewable energy-based generator, such as those powered by solar or wind energy.

The power from the grid 302 and the generator 304 may be managed by a DC/DC converter 306. The power from the grid 302 is managed by the control unit 202. The DC/DC converter 306 provides lower DC voltage, such as 12 or 24 VDC power, for ancillary systems on the mobile crusher 100, controller operation, and lead acid battery charging, which regulates the voltage levels to ensure consistent and efficient power supply to the various components of the mobile crusher 100. The control unit 202 maintains and manages the stability of the DC powertrain system 300, adapting the input voltage to the required levels for different components.

The DC powertrain system 300 also includes an on-board charger 308, which is responsible for charging the battery energy storage system (BESS). The on-board charger 308 allows the battery to be recharged from both the grid 302 and the generator 304, ensuring that the mobile crusher 100 can maintain operational readiness even when disconnected from the grid. The on-board charger 308 allows for charging from commercially available Electrical Vehicle Supply Equipment (EVSE), acting as a supplementary form of charging. The power will flow from the grid 302 or the generator 304, through the transformer 214 and rectifier, and then into the battery 207.

A Battery Thermal Management System (BTMS) 310 is integrated into the DC powertrain system 300 to maintain the battery at an optimal operating temperature. The BTMS 310 includes both cooling and heating elements that prevent the battery from overheating or freezing, thus extending its lifespan and maintaining its efficiency.

The DC powertrain system 300 further comprises a plurality of hydraulic components that facilitate the movement and operation of the mobile crusher 100. This includes a hydraulic pump 312, which provides the necessary hydraulic pressure to various actuators and systems, and a hydraulic valve 314, which controls the flow of hydraulic fluid to different parts of the machine.

The DC powertrain system 300 also features several hydraulic motors 316 that convert hydraulic energy into mechanical energy, driving various components of the mobile crusher 100. These hydraulic motors 316 are essential for tasks such as operating the rock crushing assembly 106 and operating the ground engaging elements 104.

The DC powertrain system 300 is centrally controlled by the control unit 202, which coordinates the power flow from the grid 302, generator 304, and battery, ensuring that the mobile crusher 100 operates efficiently and reliably. The control unit 202 manages the switching between different power sources or their concurrent use, depending on the operational needs and availability of power. The control unit 202 also monitors the state of charge of the battery 207 and directs the on-board charger 308 to recharge the battery 207 when necessary. Additionally, the control unit 202 oversees the operation of the BTMS 310, adjusting the thermal management to keep the battery within its optimal temperature range. The on-board charger 308 will charge from the EVSE if no other power sources are available or the battery 207 needs to be charged during storage or troubleshooting events.

By managing these components, the DC powertrain system 300 provides a robust and flexible power solution for the mobile crusher 100. It ensures continuous operation, even in challenging environments, by leveraging multiple power sources and advanced power management strategies. This system enhances the overall efficiency and functionality of the mobile crusher 100, making it a versatile and reliable tool for rock processing applications.

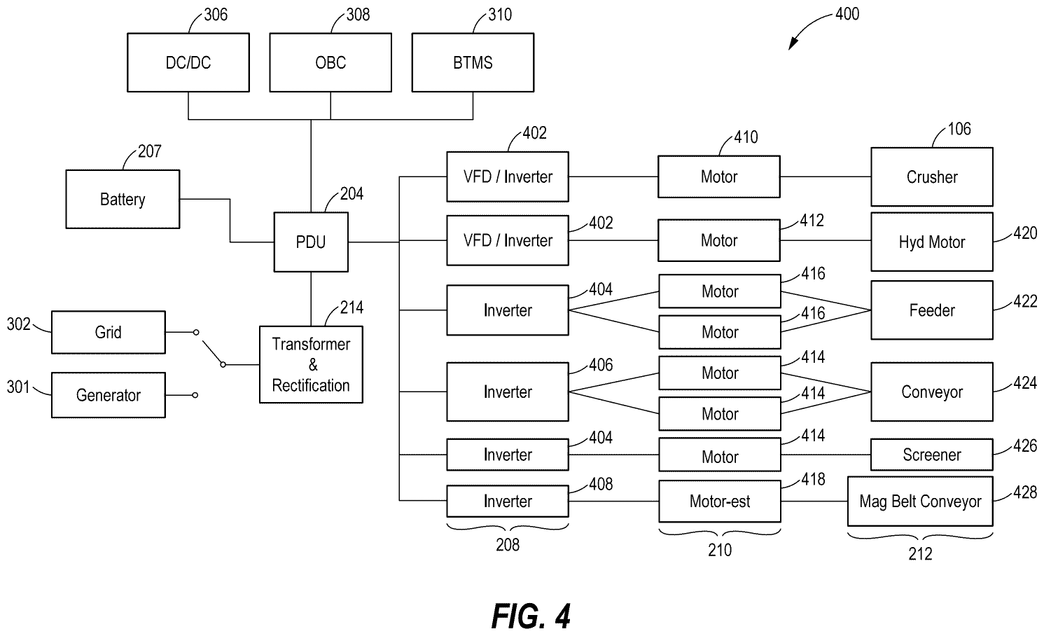

Referring now to FIG. 4, FIG. 4 illustrates a second DC powertrain system 400 of the mobile crusher 100, according to another embodiment of the present disclosure. The second DC powertrain system 400 is designed to enhance the flexibility and efficiency of the mobile crusher 100 by integrating multiple inverters and motors to power various components of the crusher.

The system includes several Variable Frequency Drives (VFDs)/inverters 402, 404, 406, and 408, each connected to specific motors and components of the mobile crusher 100 and each having a rating ranging from 5 KW-160 KW, and higher, as generally known in the arts. A first VFD/inverter 402 is connected to a electric motor 410, which drives the rock crushing assembly 106. This setup ensures that the primary crushing function receives sufficient power to process large rocks effectively. The first VFD/inverter 402 may also be connected to a motor 412, which further drives a hydraulic motor 420. This configuration supports additional hydraulic functions within the mobile crusher 100, enhancing its operational capabilities.

A second VFD/inverter 404 is connected to a motor 416, which powers a feeder system 422, including two motors. This arrangement ensures a steady and controlled flow of rocks into the crusher assembly, maintaining the efficiency of the crushing process. Additionally, another second VFD/inverter 404 may be provided and connected to a motor 414, which powers a screener 426, facilitating the sorting and separation of crushed materials based on size. The second VFD/inverter 404.

A third VFD/inverter 406 is connected to a motor 414, which drives a conveyor system 424, including two of the motors 414. The conveyor system 424 transports crushed materials from the crusher to subsequent processing stages or storage areas, ensuring continuous workflow. The third VFD/inverter 406.

A fourth VFD/inverter 408 in the system is connected to a motor 418, which powers a magnetic belt conveyor 428. This magnetic belt conveyor 428 is designed to remove metallic contaminants from the crushed material, ensuring the purity and quality of the final product.

Each VFD/inverter in the second DC powertrain system 400 plays a critical role in managing the power supply to its respective motor and component, ensuring optimal performance and energy efficiency. By utilizing multiple inverters and motors, the system provides a robust and adaptable solution for the various operational demands of the mobile crusher 100. This advanced powertrain configuration not only enhances the mobile crusher 100's productivity but also allows for precise control and adjustment of each component's performance, contributing to the overall efficiency and effectiveness of the mobile rock crushing operation.

The electrical powertrain system for the mobile crusher 100 is designed to ensure efficient and reliable operation by integrating various components that manage power distribution and control. Each element within the system plays a crucial role in maintaining the overall functionality and performance of the mobile crusher 100.

The DC electrical supply network serves as the primary conduit for distributing electrical power throughout the system, ensuring that all components receive the necessary power for operation.

The electric motor 410 connected to the DC electrical bus is responsible for driving the rock crushing assembly 106, converting electrical energy into mechanical energy required for crushing operations.

The battery 207 connected to the DC electrical bus provides stored electrical energy, ensuring that the mobile crusher 100 can operate even when not connected to an external power source. The battery 207 is for maintaining continuous operation during transitions between power sources or when operating in remote locations. The battery 207 is critical for maintaining operation during transient load conditions where system response is critical.

The generator 304 provides an alternative power source to the battery, supplying electrical power when the mobile crusher 100 is not connected to the grid. The generator ensures that the crusher can operate independently of external power supplies, enhancing its versatility and reliability.

The PDU 206 manages the allocation of electrical power to different components of the mobile crusher 100. The PDU 206 ensures that each component receives the appropriate amount of power for optimal operation, preventing overloads and ensuring efficient energy use. The PDU 206 may includes fuses to adequately protect the system from overcurrent events and faults. It may also contain an isolation monitoring device, contactors, capacitors, and other potential electrical devices.

The rectifier or transformer 214, which may be an isolation transformer, converts AC power from the grid or generator to DC power, ensuring that the electrical components receive the correct type of power. This component also isolates the electrical system, preventing faults and enhancing safety. The transformer 214 may an isolation transformer and a rectifier, converter, or an inverter with an active front end (AFE).

The DC/DC converter 306 regulates voltage levels within the electrical system, adapting the input voltage to the specific requirements of different components. This converter ensures that all components receive stable and efficient power.

The on-board charger 308 is designed to charge the battery 207 from an external power source, such as the grid 302 or generator 304. The on-board charger 308 ensures that the battery 207 remains charged and ready for use, for charging from commercially available EVSE, maintaining the operational readiness of the mobile crusher 100. The on-board charger 308 receives power from the EVSE and can be powered from the grid 302, the generator 304, or battery 207.

The BTMS 310 maintains the battery at an optimal temperature, preventing overheating or freezing. This system includes cooling and heating elements that extend the battery's lifespan and maintain its efficiency.

The control unit 202 is central to managing the entire powertrain system, coordinating power flow from the grid, generator, and battery. The control unit ensures efficient and reliable operation by dynamically adjusting power distribution based on operational needs and available power sources.

The hydraulic pump 312, hydraulic valve 314, and hydraulic motors 316 are crucial for operating the hydraulic systems of the mobile crusher 100. These components provide the necessary hydraulic pressure and control for various actuators and systems, enhancing the machine's operational capabilities.

The VFDs/inverters 402, 404, 406, and 408 manage the power supply to specific motors and components, ensuring optimal performance and energy efficiency. These inverters allow for precise control and adjustment of each component's performance, contributing to the overall efficiency of the mobile crusher 100. By integrating these components, the electrical powertrain system ensures that the mobile crusher 100 operates efficiently and reliably in various environments and conditions, providing a robust and adaptable solution for rock processing applications

### INDUSTRIAL APPLICABILITY

In operation, the present disclosure finds applicability in numerous industries, including but not limited to construction, mining, and quarry operations. Specifically, the rock crusher powertrain system and methods described herein can be employed in mobile rock crushing equipment, which is essential in the processing of raw materials in these industries. The disclosed systems, machines, and methods of this invention are particularly useful for sites where flexibility in power source and mobility are crucial.

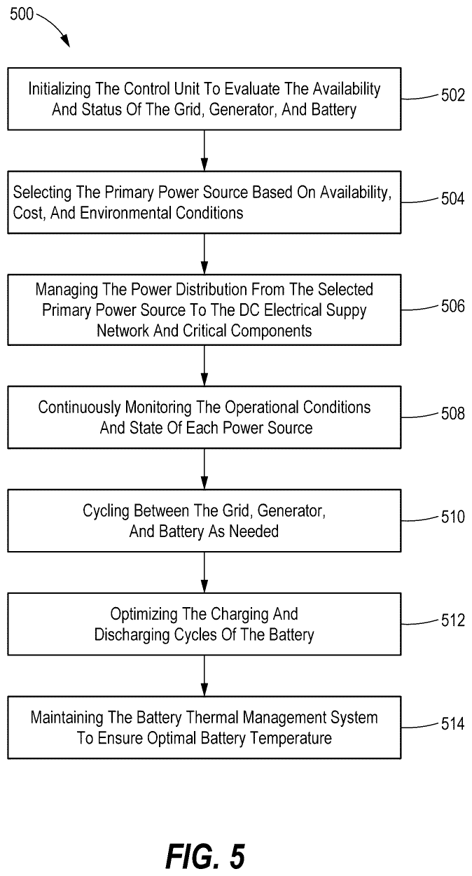

Referring now to FIG. 5, FIG. 5 is a flow-chart of a method 500 of cycling between power sources, including grid, generator, and battery, to power the mobile crusher 100, according to another embodiment of the present disclosure. This method 500 is designed to optimize the use of available power sources, ensuring continuous and efficient operation of the mobile crusher 100 in various operational environments.

The method 500 begins with the initialization step 502, where the control unit 202 evaluates the availability and status of the grid 302, the generator 304, and the battery 207. The control unit 202 uses data from sensors and communication interfaces to assess the current state of charge of the battery 207, the operational status of the generator 304, and the availability of power from the grid 302.

In step 504, the control unit 202 selects the primary power source based on predefined criteria such as availability, cost, and environmental conditions. For instance, when grid power is available and stable, it may be selected as the primary power source due to its cost-effectiveness and reliability. In remote or off-grid locations, the generator 304 might be chosen as the primary power source. If both grid and generator power are unavailable or unsuitable, the control unit 202 will prioritize the use of the battery 207.

Step 506 involves the control unit 202 managing the power distribution from the selected primary power source. The power distribution unit 206 allocates the appropriate amount of power throughout the DC electrical supply network, which in turn powers the electric motor 410, the rock crushing assembly 106, and other critical components such as the hydraulic pump 312, hydraulic valve 314, and hydraulic motors 316.

In step 508, the control unit 202 continuously monitors the operational conditions and the state of each power source. This monitoring includes checking the battery 207's state of charge, the generator's fuel levels and operational status, and the grid's power availability and stability. The control unit 202 uses this real-time data to make dynamic adjustments to the power distribution, ensuring that the mobile crusher 100 operates efficiently and without interruption.

When a change in power source is required, step 510 is executed. This step involves the control unit 202 seamlessly switching between the grid 302, generator 304, and battery 207 as needed. For example, if the grid power becomes unstable or unavailable, the control unit 202 will switch to the generator 304 or the battery 207 to maintain continuous operation. The control unit 202 ensures that this transition is smooth and does not affect the performance of the rock crushing assembly 106 or other critical systems.

In step 512, the control unit 202 optimizes the charging and discharging cycles of the battery 207. When grid power is available, the on-board charger 308 receives power from the EVSE which may receive power from the grid 302, ensure optimal state of charging and power remains. Similarly, when the generator 304 is running, excess power can be used to charge the battery 207. The control unit 202 also manages the discharge of the battery 207 to provide power during peak demands or when other power sources are insufficient.

The final step 514 involves maintaining the battery thermal management system 310 to ensure the battery 207 operates within its optimal temperature range. The control unit 202 adjusts the BTMS 310 as needed to provide cooling or heating, preventing the battery from overheating or freezing, and thereby extending its lifespan and maintaining efficiency.

The control unit 202 manages power flow from various sources, including the grid 302, generator 304, and battery 207, ensuring that the electric motor 410, battery 207, and generator 304 receive the appropriate amount of power for optimal operation. The control unit 202 also includes error logging and diagnostics capabilities, which can increase and decrease function power to maximize overall process efficiency. Additionally, the power distribution unit 206 (PDU 206) includes fuses to protect the system from over-current events and faults. The PDU 206 may also contain an isolation monitoring device, contactors, capacitors, and other potential electrical devices, operating similarly to a fuse panel in a house, ensuring safe and efficient power distribution throughout the mobile crusher 100.

From the foregoing, it can be seen that the technology disclosed herein has significant industrial applicability in a variety of settings, including but not limited to construction, mining, and quarrying industries that require robust, flexible, and efficient rock crushing solutions. This adaptability ensures that the rock crusher powertrain system can meet the evolving demands of these industries while supporting sustainable operational practices.

What is claimed is:

1. An electrical powertrain system for a mobile crusher, comprising:
a DC electrical supply network;
a plurality of motors connected to the DC electrical supply network and configured to drive a plurality of machine operations;
a plurality of batteries connected to the DC electrical supply network, providing electrical energy;
a power distribution unit (PDU) managing DC power to different components of the mobile crusher; and
a control unit configured to manage a charging and discharging cycles of the plurality of batteries for operation of the plurality of machine operations.

2. The electrical powertrain system of claim 1, further comprising at least one of a plurality of power sources chosen from the group consisting of:
a generator connected to an inverter, converting an AC power to DC power, the inverter in further connection to the PDU;
a grid supply in connection to an isolation transformer for converting AC power to DC power in further connection to the PDU;
a grid supply in connection to an isolation transformer for converting AC power to DC power in further connection to the PDU, an isolation transformer and a rectifier, a converter, and inverter with an active front end (AFE);
a plurality of solar panels connected to the PDU;
a photovoltaic system;
a battery energy storage system (BESS);
a plurality of alternative energy sources producing DC power connected to the PDU;
a plurality of alternative energy sources producing AC power connected to the inverter, converting AC power to DC power, the inverter in further connection to the PDU; and
the control unit is further configured to manage the charging and discharging cycles of the plurality of power sources for operation of the plurality of machine operations.

3. The electrical powertrain system of claim 1, further comprising a plurality of inverters converting DC power to AC power for the plurality of motors.

4. The electrical powertrain system of claim 2, further comprising an on-board charger configured to charge the battery from one of the plurality of power sources.

5. The electrical powertrain system of claim 2, further comprising a battery thermal management system including cooling and heating elements configured to prevent the plurality of batteries from overheating or freezing.

6. The electrical powertrain system of claim 1, wherein at least one of the plurality of machine operations powered by the plurality of motors is chosen from the group consisting of rock crusher assembly, hydraulic pumps, air-condition system, conveyor systems, and electronic systems.

7. The electrical powertrain system of claim 2, further comprising a DC/DC converter regulating voltage levels DC/DC converts the DC electrical supply network to a lower voltage to supply electrical power to ancillary systems and components.

8. A mobile crusher comprising:
a frame;
ground engaging elements supporting the frame;
a rock crushing assembly mounted on the frame, configured to process rocks into smaller pieces;
an electrical powertrain system including:
a DC electrical supply network mounted to the frame;
a plurality of motors connected to the DC electrical supply network and configured to drive a plurality of machine operations;
a plurality of batteries connected to the DC electrical supply network, providing electrical energy;
a power distribution unit (PDU) managing DC electrical power to different components of the mobile crusher; and
a control unit configured to manage a charging and discharging cycles of the plurality of batteries for operation of the plurality of machine operations.

9. The mobile crusher of claim 8, further comprising at least one of a plurality of power sources chosen from the group consisting of:
a generator connected to an inverter, converting AC power to DC power, the inverter in further connection to the PDU;
a grid supply in connection to an isolation transformer for converting AC power to DC power in further connection to the PDU;
a plurality of solar panels connected to the PDU;
a plurality of alternative energy sources producing DC power connected to the PDU;
a plurality of alternative energy sources producing AC power connected to the inverter, converting AC power to DC power, the inverter in further connection to the PDU; and
the control unit is further configured to manage the charging and discharging cycles of the plurality of power sources for operation of the plurality of machine operations.

10. The mobile crusher of claim 8, further comprising a plurality of inverters converting DC power to AC power for the plurality of motors.

11. The mobile crusher of claim 9, further comprising an on-board charger configured to charge the battery from one of the plurality of power sources.

12. The mobile crusher of claim 8, further comprising a battery thermal management system including cooling and heating elements configured to prevent the plurality of batteries from overheating or freezing.

13. The mobile crusher of claim 8, wherein at least one of the plurality of machine operations powered by the plurality of motors is chosen from the group consisting of rock crusher assembly, hydraulic pumps, air-condition system, conveyor systems, electronic systems.

14. The mobile crusher of claim 8, further comprising a DC/DC converter regulating voltage levels DC/DC converts the DC electrical supply network to a lower voltage to supply electrical power to ancillary systems and components.

15. The mobile crusher of claim 8, further comprises screens.

16. The mobile crusher of claim 8, wherein the rock crushing assembly comprises a jaw crusher, a cone crusher, or an impact crusher.

17. The mobile crusher of claim 1, further comprising a hydraulic pump and hydraulic motor configured to power hydraulic systems of the mobile crusher.

18. A method of powering a mobile crusher having a DC electrical supply network from a plurality of power sources, the method comprising:
initializing, via a control unit, to evaluate a status of the plurality of power sources;
selecting a power source chosen from the plurality of power sources based on availability, cost, and environmental conditions;
managing power distribution from the power source to the DC electrical supply network and a plurality of mobile crusher operational systems, via the control unit;
continuously monitoring, via the control unit, the operational conditions and state of the plurality of power sources; and
cycling power distribution between the plurality of power sources to the plurality of mobile crusher operational systems.

19. The method of claim 18, wherein the plurality of power sources include a grid, a generator, a turbine, a fuel cell, a photovoltaic, and a battery energy storage system (BESS), further comprising:
optimizing a charging and discharging cycles of the battery via the control unit and an on-board battery charger;
supplying electrical power to a power distribution unit to a plurality of electric motors from the plurality of power sources; and
maintaining optimal battery temperature via a battery thermal management system.

20. The method of claim 19, further comprising:
providing a rock crusher having an electric motor configured to drive a rock crushing assembly and a powertrain control system configured to manage power sources;
controlling the powertrain control system to switch between the plurality of power sources or to use them concurrently to maintain continuous operation of the rock crushing assembly; and
tramming the rock crusher using DC power from plurality of power sources.
